(19) United States
(12) Patent Application Publication
(10) Pub. No.: US 2018/0015396 A1
(43) Pub. Date: Jan. 18, 2018

(54) OIL FILTER WITH DRAIN MECHANISM

(71) Applicant: GLENN HUFF, HACKETTSTOWN, NJ (US)

(72) Inventor: GLENN HUFF, HACKETTSTOWN, NJ (US)

(21) Appl. No.: 15/212,016

(22) Filed: Jul. 15, 2016

(51) Int. Cl. B01D 29/92; F01M 11/04; B01D 29/11; B01D 35/00; F01M 11/03

(52) U.S. Cl. CPC B01D 29/92; B01D 35/005; F01M 11/03; B01D 29/114; F01M 11/0458; B01D 2201/167; B01D 2201/34

(57) ABSTRACT

An oil filter with drain mechanism comprises a canister having a continuous wall, a closed end and an open end; a filter element; a means for retaining the filter element within the canister, the means for retaining the filter closing the canister open end; a means for sealing the oil filter against a surface, the means for sealing attached to the means for retaining the filter element; a means for attaching the oil filter to the surface; and a drain valve to drain fluid accumulated in the oil filter from the filter. Another embodiment includes an oil filter and a separate drain valve, which can be attached to the filter prior to the filter's removal from a surface, such as an engine. This embodiment is designed for use where there is limited space for access to a filter.

### FIELD OF THE INVENTION

Embodiments of the present invention relate to a filter for use on an engine, such as that of a motor vehicle, or with other devices where an engine is used to power or drive the device. In particular, embodiments of the present invention are an oil filter. The oil filter of the present invention comprises a housing surrounding a filter element, a means for attaching the filter to the engine, such as a plurality of threads at an end of the container, and a drain valve extending outwards from the container. The spillage of oil that has accumulated in an oil filter is a common occurrence, no matter how thorough or careful one is when draining the engine oil prior to removing the oil filter. When it is necessary to change the engine oil and replace the oil filter, and generally after the engine oil has been drained from the engine, the oil filter drain valve is opened to allow oil accumulated within the filter to drain out of the filter, enabling the user to remove the oil filter from the engine without having the accumulated oil from the filter spilling onto their hands, floor and/or clothing.

### BACKGROUND OF THE INVENTION

Changing the engine oil and an oil filter are among the most common vehicle maintenance requirements. After the oil has been drained from the engine, the oil filter is loosened and then removed. A common problem is that no matter how careful one is when removing the filter, or how thorough one might be when draining the oil from the engine, accumulated oil remaining in the filter leaks therefrom, often spilling onto either the user's hands or clothing, the floor or elsewhere in the work area.

While placing an absorbent material or paper towels beneath the area where the oil filter is situated might minimize the spread of any spilled oil, it does not really solve the problem of spilled oil, only serving to reduce its' spread. The absorbed oil ends up being discarded with the substrate onto which it has been absorbed, and will typically end up in a landfill rather than being recycled.

To solve this problem, this inventor has designed an oil filter that includes a drain mechanism so that oil accumulated in the filter can be drained from the filter prior to the removal of the filter from the engine, thereby minimizing the spillage of oil from the filter. Embodiments of the present invention also have a positive effect on the environment because more waste oil is recovered for reprocessing, reducing the amount of oil that may be disposed of in the environment with the discarded oil filter.

### BRIEF SUMMARY OF THE INVENTION

An object of the present invention is to provide an oil filter that contains a drain valve to enable oil accumulated in the filter to be drained prior to removal of the filter from an engine.

Another object of the present invention is to provide an oil filter that contains a retractable drain valve to facilitate removal of oil accumulated in the filter to be drained prior to removal of the filter from an engine.

Embodiments of the present invention provide an oil filter comprising a housing including a filter element therein, a means for attaching the oil filter to an engine, and a drain valve extending through the housing and into the filter element, such that when the drain valve is opened, oil accumulated within the oil filter is drained from the oil filter. One embodiment of the present invention is an oil filter with drain mechanism that comprises a canister having a continuous wall, a closed end and an open end; a filter element; a means for retaining the filter element within the canister, the means for retaining the filter closing the canister open end; a means for sealing the oil filter against a surface, the means for sealing attached to the means for retaining the filter element; a means for attaching the oil filter to the surface; and a drain valve to drain fluid accumulated in the oil filter from the filter. In this embodiment, the drain valve comprises a stem, a valve and a drain spout; the stem penetrates the oil filter canister, and in another embodiment, penetrates the filter element. Another embodiment includes an oil filter and a separate drain valve, which can be attached to the filter prior to the filter's removal from a surface, such as an engine. This embodiment is designed for use where there is limited space for access to a filter.

### BRIEF DESCRIPTION OF THE SEVERAL VIEWS OF THE DRAWING

FIG. 1 is a plan view of a conventional oil filter.

FIG. 2 is an exploded view of a conventional oil filter.

FIG. 3 illustrates two embodiments of the oil filter of the present invention.

FIG. 3A illustrates an oil filter embodiment attached to an engine in an inverted position; and

FIG. 3B an oil filter embodiment are attached in an upright position.

FIG. 4 illustrates an alternate embodiment of an oil filter of the present invention.

FIG. 5 illustrates an alternate embodiment of the present invention, where;

FIG. 5A shows the drain valve in the closed position; and

FIG. 5B shows the drain valve in the open position, and accumulated oil draining from the filter.

### DETAILED DESCRIPTION OF THE INVENTION

A common problem when one changes the oil and/or the oil filter of an engine, whether the engine is mounted in a vehicle such as an automobile, truck, tractor, other devices such as lawnmowers, snow machines, snow throwers, or engines that power other devices, such as compressors, and the like, is that there is an accumulation of oil within the filter element, and upon removal of the filter from the engine, that accumulated oil tends to spill, commonly onto the hands or clothes of the user, the engine, the floor or elsewhere in the work area. This spillage tends to occur no matter how careful or thorough one has been in draining the oil from the engine, or while removing the filter from the engine.

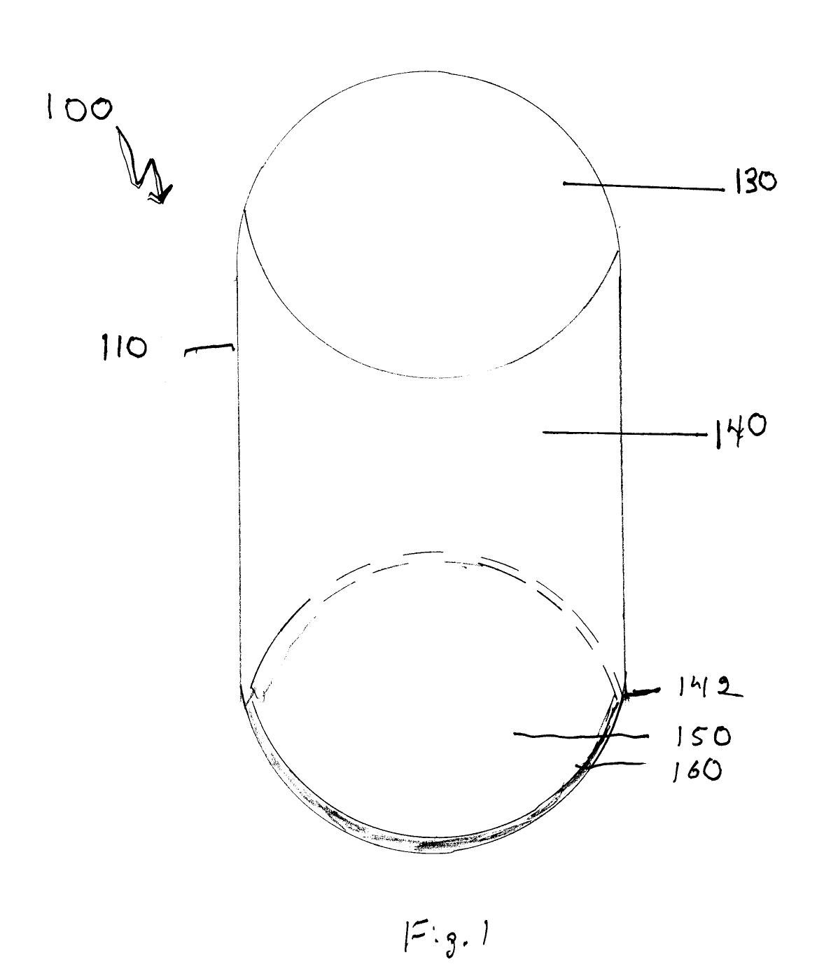

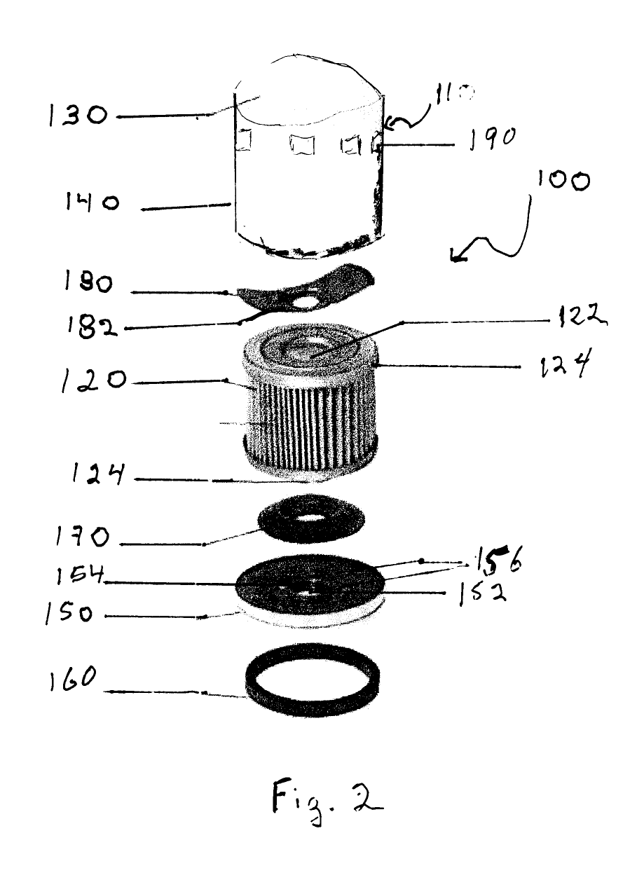

FIGS. 1-2 illustrate a typical conventional oil filter 100, which comprises a canister 110, and a filter element 120 that is positioned in the canister 110. The canister 110 comprises a top 130 and a continuous wall 140 that terminates in a lip 142. An end cap 150 retains the filter element 120 within the canister 110. A sealing means 160, such as a gasket or O-ring, is positioned proximate the outer surface of the end cap 150, to insure a seal between the filter 100 and a surface, such as that of an engine (not shown), onto which the filter 100 is attached.

An anti-drawback valve 170 that fits within an end of the filter element 120 is positioned between the filter element 120 and the end cap 150. The end cap 150 includes a central opening 152 which has a plurality of threads 154 to allow the filter 100 to be attached to an engine. Other filter embodiments may not have a threaded central opening, and instead may include a plurality of threads (not shown) proximate the outer edges of the end cap 150 for mounting onto a different type of engine. End cap 150 further includes a plurality of holes 156 therein, the holes 156 facilitating the flow of oil.

The canister wall 140 may include a plurality of indentations 190, grooves (not shown) or other means to grip the filter for mounting it and/or removing it. There are numerous types of oil filters on the market, and some are designed to be removed with a filter wrench that spans the filter, and others are designed to be removed by a removal of a nut (not shown) from atop the canister 110. FIGS. 1 and 2 are intended to be representative of a “typical” oil filter, and are not intended to encompass all filter variations.

A threaded receptacle contained within the canister 110's inside receives a threaded rod (not shown) that extends from the surface and onto which the filter 100 is mounted. Other embodiments of the oil filter may include a plurality of threads along the lip, enabling the filter to be attached to the engine. The filter element in the first embodiment 100 includes a longitudinal opening within the core 122, through which the threaded rod extends to connect to the threaded receptacle.

The filter element 120 generally is a paper filter, such as that shown in FIG. 2, and the filter element 120 is fluted to provide a large surface area for filtration. Depending upon the intended use of the engine to which the filter is attached, for example, routine automotive use or high performance use (such as racing), or for use in jet aircraft, the filter element might include metallic, plastic, or other components to enable the filter element to withstand the conditions of use.

The filter is retained on a core 122 and supported by an end support 124 at both its top and bottom ends. The core 122 may be metallic. A leaf spring 180 is mounted on the upper end of the filter element 120, and may include a central support 182 to keep the filter element 120 in position within filter 100.

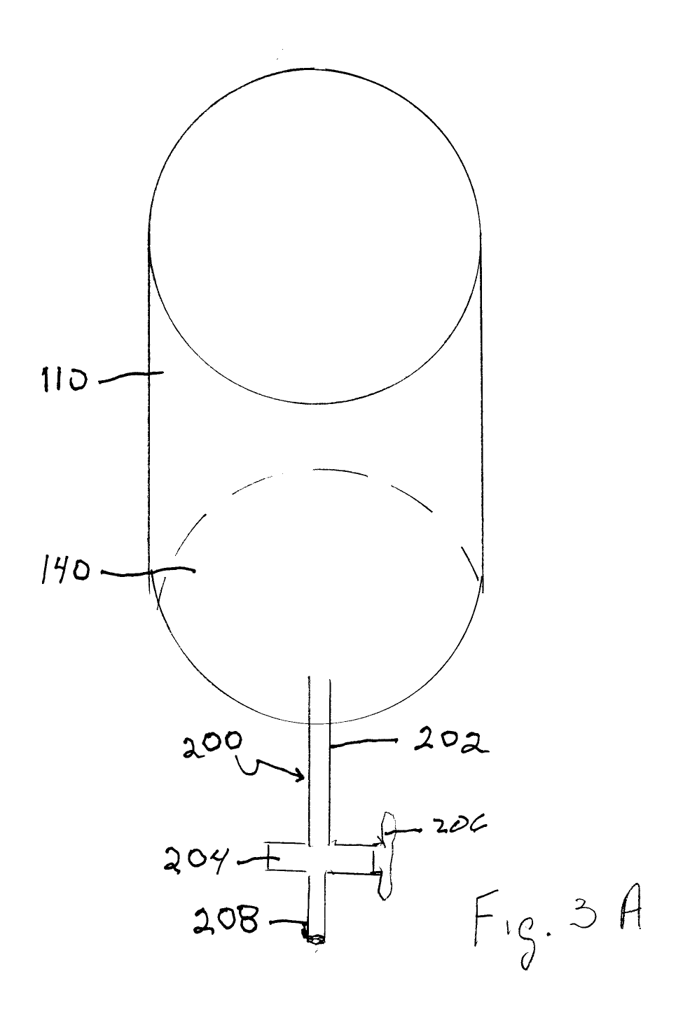

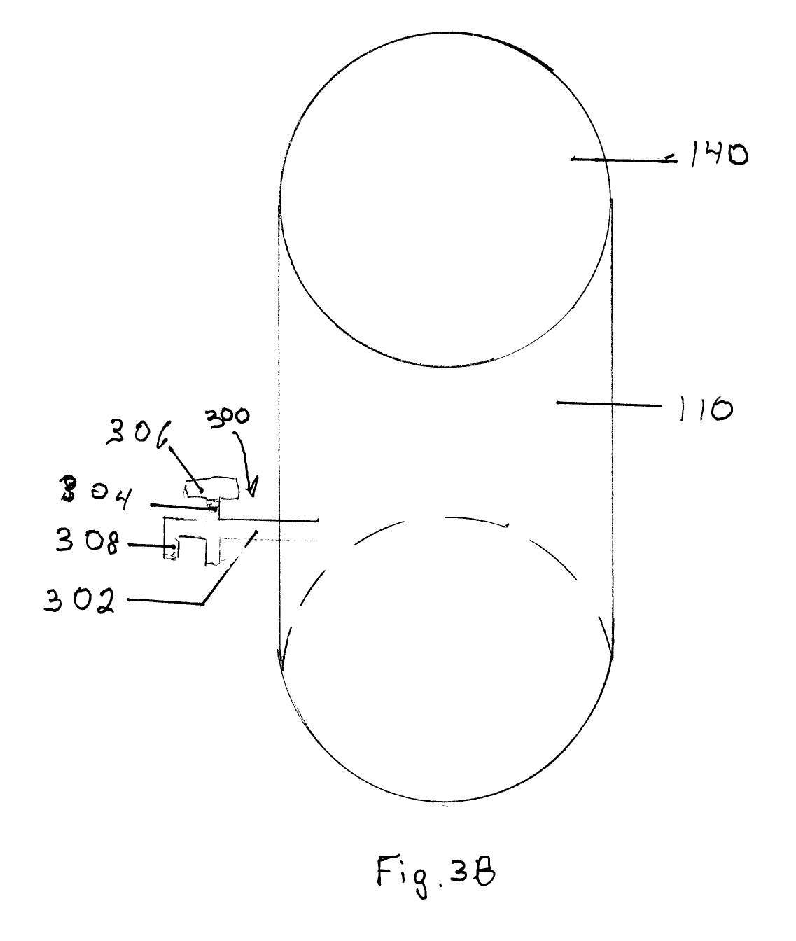

A drain (or spigot) is connected to the oil filter canister 110 as shown in FIG. 3. FIG. 3A illustrates an oil filter that is attached to an engine in an inverted position, and drain 200 is mounted through the top 140 of the filter. For oil filters that are attached in an upright position, the drain 300 is mounted towards the base of the filter (FIG. 3B).

The spigot 200 comprises a stem 202, a valve 204, a valve lever 206 and a spout 208 (FIG. 3A). The stem 202 is elongated, and in other embodiments, the spout 208 may be tapered as it extends from the valve 204. The valve 204 can be a cone valve, a ball valve, or other valve known to those skilled in the art. The valve lever 206 can be selected from those typically used in valves, such as, but not limited to, a lever, wheel or a ball valve. In the embodiment shown in FIG. 3A, a lever 206 is used.

Where the filter 100 is mounted in an upright position, the spigot 300 is mounted towards the base of the filter (FIG. 3 B). Spigot 300 comprises a stem 302, a valve 304 and a spout 306. In this embodiment the stem 302 penetrates the filter element 120.

In other embodiments, the stem 202 or 302 could be positioned between the canister wall 140 and the filter element 120, or between the bottom of the filter element 120 and the end cap 150. Factors that can determine the position of the stem 202 or 302 in the filter include, for example only, the intended use of the filter, whether for routine or high-performance use, and/or the particular type of filter element 120 employed, or the size of the engine/device to be used with the filter. The length of the stem 202 or 302 and size of the valve 204 or 304 may be varied, depending upon the clearance available between the oil filter 100 and the engine.

As described in the preceding paragraphs, the drain 200 or 300 may comprise a variety of forms, but it is to be understood that embodiments of the present invention do not utilize a threaded nut for draining accumulated oil from the filter.

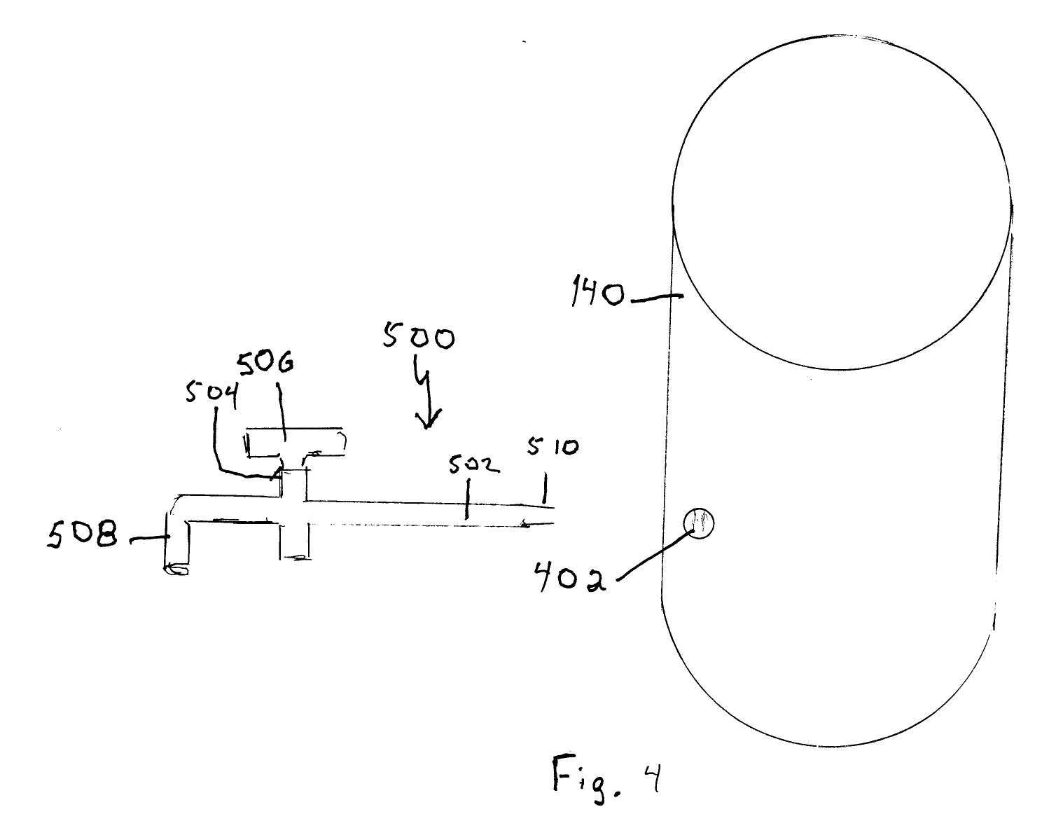

Another embodiment of the present invention (FIG. 4) is intended for use with filters on engines with limited space between the filter and its surroundings, such that a filter with a protruding spigot would not be practical to mount onto the engine. In this embodiment, the canister wall 140 includes a seal 402 that is sufficiently strong to withstand the routine pressure and use conditions of the filter 100, and yet the seal 402 can be punctured when the spigot 500 is inserted through it and penetrates the filter element 120. The seal can be a metallic compound, having sufficient strength to withstand the pressure and rigors of use for an oil filter, yet sufficiently frangible such that it can be punctured by the stem of the drain valve inserted therethrough. The seal could be a metallic foil, a plastic or rubber material, or a combination of one or more of these materials.

The spigot 500 is supplied as a separate component, and after the oil has been drained from the engine, the spigot 500 is inserted through the seal 402 and into the filter canister 110 where it punctures a portion of the filter element 120. The spigot 500 comprises a stem 502, a valve 504, a valve lever 506 and a spout 508 (FIG. 4). The stem 252 is elongated, and in other embodiments, the spout 508 may be tapered as it extends from the valve 204. The valve 504 can be a cone valve, a ball valve, or other valve known to those skilled in the art. The valve lever 506 can be selected from those typically used in valves, such as, but not limited to, a lever, wheel or a ball valve. In the embodiment shown in FIG. 4, a lever 506 is used. The stem 502 may include a set of tapered or sharpened ends 510, to facilitate puncturing of the seal 402.

After the spigot 500 has been inserted through the seal 402 and, the spigot valve 502 is then opened, the accumulated oil in the filter allowed to drain, the spigot is closed, removed from the oil filter and disposed, and the filter then removed and disposed. The seal 402 could be positioned at a lower portion of the canister 110, and the spigot 500 having a shorter length, such that the spigot 500 does not puncture the filter element 120, but is positioned in the space between the filter element 120, the canister 110 and the filter end cap 150.

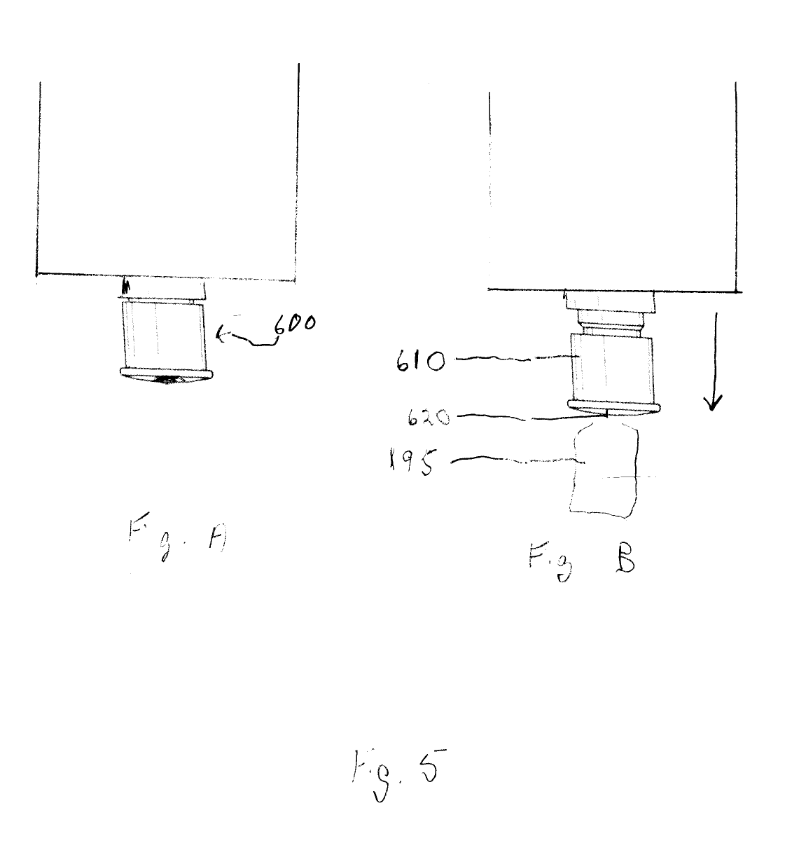

In another embodiment (FIG. 5), the drain may comprise a valve mechanism similar to that of the dispenser valve used in the closure of a sports bottle, in which in the closed position, the valve is positioned proximate the closure, and when the valve is pulled away from the closure, the valve is in the open position. For the filter embodiment shown in FIG. 6 (attached to engine with top facing downward), the valve cap 610 could be pulled downward (arrow in FIG. 6B) to open the valve 600 and allow the accumulated oil 195 in the filter to drain through the opening 620 in the valve cap 610. For such a valve to be employed in embodiments of the present invention, the valve could be manufactured from a metal that is sufficiently strong to withstand the temperatures of an engine and engine oil when the engine is in operation, such as steel, aluminum or other suitable metal or combinations thereof. The valves utilized on sports bottles typically are manufactured from a plastic and/or silicone. Because the various components of the valve 600 are known to those skilled in the art, they will not be described further.

The specification has shown embodiments of the present invention used with a typical oil filter for an automobile engine. However, it is to be understood and included that embodiments of the present invention can be used with most other types of oil filters, such as filters for use with synthetic motor oils, filters for engines on vehicles with high mileage, for example only, vehicles with greater than 75,000 miles on their odometer, or other filters designed to be changed at short (3000-5000 miles), “typical” (6,000-10,000 miles), rough service, such as taxicabs, commercial use for diesel engines, commercial trucks, tractors for tractor-trailers, farm and agricultural vehicles, and the like, lawn and garden vehicles and accessories, and engines used for air compressors and other industrial functions.

Although this invention has been described with a certain degree of particularity, it is to be understood that the present disclosure has been made only by the way of illustration, and that numerous changes in construction and arrangement of parts may be resorted to without departing from the spirit and scope of the invention.

I claim:

1. An oil filter comprising:
a canister comprising a continuous wall, a closed end and an open end;
a filter element, the filter element positioned within the canister;
a means for retaining the filter element within the canister, the means for retaining the filter closing the canister open end;
a means for attaching the oil filter to a surface;
a means for sealing the oil filter against the surface, and
a means for draining fluid accumulated in the oil filter from the oil filter.

2. The oil filter as described in claim 1, wherein the means for draining is a valve.

3. The oil filter as described in claim 2, wherein the valve comprises a stem, a valve mechanism, and a spout, the stem attached to the canister.

4. The oil filter as described in claim 3, wherein the stem penetrates the canister wall and penetrates the filter element.

5. The oil filter as described in claim 3, wherein the valve is positioned in the canister wall and is proximate the means for retaining the filter element.

6. The oil filter as described in claim 3, wherein the stem penetrates the canister wall and is positioned between the filter element and the canister wall.

7. The oil filter as described in claim 3, wherein the stem penetrates the canister wall and is positioned between the filter element and the means for attaching the oil filter to the surface.

8. The oil filter as described in claim 3, wherein the means for sealing is a gasket.

9. The oil filter as described in claim 3, wherein the means for attaching is a plurality of threads.

10. An oil filter comprising:
a canister comprising a continuous wall, a closed end and an open end;
a filter element, the filter element positioned within the canister;
a means for retaining the filter element within the canister, the means for retaining the filter closing the canister open end;
a means for sealing the oil filter against a surface, the means for sealing positioned proximate the means for retaining the filter element;
a means for attaching the oil filter to the surface, the means for attachment including a plurality of openings for fluid circulation; and
a drain valve for draining fluid accumulated in the oil filter from the oil filter, the drain valve comprising a stem, a valve mechanism, and a spout, and the stem is attached to and penetrates the canister wall.

11. The oil filter as described in claim 10, wherein the stem penetrates the filter element.

12. The oil filter as described in claim 10, wherein the valve is positioned in the canister wall and is proximate the means for retaining the filter element.

13. The oil filter as described in claim 10, wherein the stem penetrates the canister wall and is positioned between the filter element and the canister wall.

14. An oil filter and drain system, the system comprising:
an oil filter comprising
a canister including a continuous wall, a closed end and an open end, the canister wall including a seal proximate the open end;
a filter element, the filter element positioned within the canister;
a means for retaining the filter element within the canister, the means for retaining the filter closing the canister open end;
a means for attaching the oil filter to a surface;
a means for sealing the oil filter against the surface, and
a valve for draining fluid from the oil filter, the valve being separate from the oil filter.

15. The filter system as described in claim 14, wherein the valve comprises a stem, a valve mechanism, and a spout, the stem attached to the canister.

16. The filter system as described in claim 15, wherein the stem is inserted into the oil filter prior to removal of the oil filter from a surface.

17. The oil filter as described in claim 15, wherein the stem penetrates the canister seal and penetrates the filter element.
